(19) United States
(12) Patent Application Publication
(10) Pub. No.: US 2026/0061727 A1
(43) Pub. Date: Mar. 5, 2026

(54) METHODS TO MODIFY PROPERTIES OF A PREVIOUSLY FORMED POLYMER ELECTROLYTE FILM AND PRODUCTS INCORPORATING SUCH FILM

(71) Applicant: Miru Smart Technologies Corp., Vancouver (CA)

(72) Inventors: Richard John Burford, Vancouver (CA); Flavio Campagnaro, Vancouver (CA); Hayley Phoeba Delima, Vancouver (CA)

(73) Assignee: Miru Smart Technologies Corp., Vancouver, BC (CA)

(21) Appl. No.: 19/132,135

(22) PCT Filed: Dec. 1, 2023
(86) PCT No.: PCT/CA2023/051606

§ 371 Date: May 22, 2025

Related U.S. Application Data
(60) Provisional application No. 63/429,443, filed on Dec. 1, 2022.

(51) Int. Cl. B32B 17/10

(52) U.S. Cl. CPC B32B 17/10981; B32B 17/10036; B32B 17/10211; B32B 17/10513; B32B 17/10935; B32B 2255/20; B32B 2307/412; B32B 2307/7376

(57) ABSTRACT

Methods of modifying a property of a prefabricated film are provided. The prefabricated film is exposed to a solvent to modify a property of the prefabricated film to provide a modified film. In some embodiments the solvent comprises a plasticizer. In some embodiments, the property comprises ionic conductivity. In some embodiments, the solvent is part of a solution comprising a reactive compound. In some embodiments, the reactive compound comprises an alkali metal salt.

### REFERENCE TO RELATED APPLICATIONS

This application claims priority from, and for the purposes of the United States the benefit under 35 USC 119 in relation to, U.S. patent application No. 63/429,443 filed on 1 Dec. 2022, which is hereby incorporated herein by reference.

### FIELD OF INVENTION

The present disclosure relates in general to processes for introducing ionic conductivity into films (e.g., polymer films) and for increasing the ionic conductivity of films (e.g., polymer films). The invention also provides methods to use the improved films as the electrolyte layer in an electrochemical device such as, for example, an electrochromic window, a battery (including a lithium ion battery or a sodium ion battery), a capacitor or a supercapacitor.

### BACKGROUND

Electrochemical devices, including but not limited to batteries, electrochromic windows, sensors, capacitors and supercapacitors, incorporate an ion-conducting interlayer, or electrolyte, which permits charge transport between electrodes. This material should be ion-conducting as well as electrically insulating.

FIG. 1 schematically depicts a multilayer architecture of a prior art electrochromic device. FIG. 1 represents a device that is connected to an external power source. The electrochromic device includes a first transparent substrate (1), a first transparent conductive layer (2), an anodic electrochromic layer or ion-storage layer (3), an ion-conductive polymer film electrolyte layer (4), a cathodic electrochromic layer (5), a second transparent electrically-conductive layer (6), and a second transparent substrate (7).

The substrates (1,7) provide a base structure for the active device materials and protection for the internal layers. The (transparent) electrically-conductive layers (2, 6) provide a means for conducting charge to and from the electrochromic layers (3, 5) from an external power source and/or control electronics and software (8). The conductive electrolyte layer (4) provides a means to transport ions between the anodic (3) and cathodic (5) electrochromic layers. For clarity, the thickness of the layers of the device, including the shape, size and scale of layers, is not drawn to scale or in actual proportion to each other, but is represented schematically.

Liquid electrolytes provide high ionic conductivity in these devices, but it may be undesirable to use liquid electrolytes where damage to the device would result in safety concerns due to leakage of the liquid electrolyte. Further, liquid electrolytes may not be suitable for large format devices due to the challenges associated with hydrostatic pressure.

For large format electrochemical devices, it may desirable for ion-conducting layers to exhibit adhesion to the substrate electrodes and mechanical stability. In some applications, particularly electrochromic windows, it is desirable for the electrolyte to exhibit optical transparency, clarity and resistance to degradation by UV and temperature variation.

Incorporation of polymers to gellate or solidify a liquid electrolyte can provide the physical properties including mechanical strength, adhesion to the electrodes, and electrode separation required to overcome the safety and hydrostatic pressure challenges of purely liquid electrolytes.

A solidified or gelled electrolyte generally consists of a blend of three principal components providing various functionality to the electrolyte: (1) a polymer component which provides the structural framework; (2) a salt which provides the mobile ions; and (3) a liquid portion which provides separation of the salt ion pair and compatibility with the polymer component. Additional components are typically added to provide functionality such as clarity, adhesion, UV stability etc. or to modify the physical properties (e.g., strength, flexibility, resiliency, Young's modulus, etc.).

The ionic conductivity of the electrolyte layer is a limiting factor in the rate performance of electrochemical devices. Therefore, it is desirable to maximize the ionic conductivity of the electrolyte layer.

Ionic conductivity in polymer films is a strong function of the ratio of plasticizer to polymer in the formulation, and more particularly the fraction of dielectric plasticizer to other electrolyte components. FIG. 5 in the U.S. Pat. No. 8,673,503 “Polyurethane gel electrolytes with improved conductance and/or solvent retention” provides a chart illustrating a near-logarithmic increase in ionic conductivity as the weight fraction of plasticizer (propylene carbonate in the case of the above referenced patent) is increased. It is therefore evident that a high fraction of plasticizer may be desired for a highly ionically conductive polymer system.

Polymer films designed for lamination processes are readily available commercially and are relatively inexpensive. These films are non-reactive and can be transported, and stored without degradation for long time periods. Free standing polymer-based ion-conducting interlayers may simplify the manufacturing process of electrochemical devices, particularly electrochromic windows, as these interlayers can be incorporated into the electrochemical device using traditional lamination processes. Extrusion is one method for manufacturing thermoplastic films as this method allows high throughput, roll-to-roll production of high quality films. However, extruding conductive materials has limits. Increased plasticizer content increases conductivity, but also impacts the manufacturability and handling of the material, as it can cause the materials to stick to machine parts, sagging as it is being extruded, resulting in non-uniform films and difficulty in the handling and processing of the films. Specifically, it is difficult to form by extrusion a free-standing polymer film at high liquid loadings, and more particularly, extrusion of thermoplastic resin formulations is challenging at liquid plasticizer fractions exceeding approximately 25 wt %. It is therefore desirable to find a method to more effectively provide free standing film (e.g., film formed typically via extrusion, casting or blown film) with high ionic conductivity that is usable in final electrochemical device assembly.

Electrolyte layers frequently require incorporation of reactive species such as, for example, lithium salts. These species are often air-sensitive; reacting with H₂O, O₂ or CO₂ in the air. This adverse reactivity makes it difficult or impossible to produce long lasting, transportable free standing electrolyte films incorporating these species except in controlled environments such as dry rooms or inert atmospheres. There is, therefore, a need for methods to incorporate these sensitive or reactive species into free standing film (e.g., film formed typically via extrusion, casting or blown film) usable in final electrochemical device assembly.

A prefabricated polymer electrolyte film can lose plasticizer(s) to evaporation during storage and handling. It is therefore desirable to have a method to provide prefabricated polymer electrolyte film with sufficient plasticizers at or near the time of final device assembly.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

One aspect of the invention provides a method for modifying a property of a prefabricated film. The method comprises providing the prefabricated film and exposing, for a treatment period and under treatment conditions, the prefabricated film to a solvent to modify the property of the prefabricated film to provide a modified film.

In some embodiments, the prefabricated film comprises a prefabricated polymer film. In some embodiments, the prefabricated film comprises aliphatic polyurethane, polyether polyurethane, polyol, thermoplastic polyurethane (TPU), aliphatic polyurethane, polyvinyl butyral (PVB), ethylene vinyl acetate (EVA), or an ionomer. In some embodiments, the prefabricated film comprises thermoplastic polyurethane (TPU). In some embodiments, the prefabricated film comprises polyvinyl butyral (PVB). In some embodiments, the prefabricated film is a free standing film. In some embodiments, the prefabricated film is extruded, cast or blown. In some embodiments, a thickness of the prefabricated film is between approximately 0.05 mm and approximately 4 mm. In some embodiments, a thickness of the prefabricated film is between approximately 0.15 mm and approximately 1.55 mm.

In some embodiments, the prefabricated film is subjected to a surface treatment prior to the step of exposing the prefabricated film to the solvent. In some embodiments, the surface treatment comprises formation of micropores and/or nanopores in or on one or both broad surfaces of the prefabricated film. In some embodiments, the micropores and/or nanopores reduce a density of the prefabricated film by between approximately 0% to approximately 50%.

In some embodiments, the solvent is part of a solution. In some embodiments, the solution comprises a reactive compound. In some embodiments, the reactive compound comprises one or more salts. In some embodiments, the reactive compound comprises one or more alkali metal salts. In some embodiments, a concentration of the one or more alkali metal salts in the solution is between approximately 0.2 M to approximately 2 M. In some embodiments, a concentration of the one or more alkali metal salts in the solution is between approximately 0.8 M to approximately 1.6 M. In some embodiments, the reactive compound comprises one or more of a lithium salt, a sodium salt, and a potassium salt. In some embodiments, the reactive compound comprises one or more lithium salts selected from the group consisting of lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato) borate, lithium difluoro (oxalato) borate, and lithium 4,5-dicyano-2-(trifluoromethyl) imidazol-1-ide. In some embodiments, the reactive compound comprises one or more of alkali metals, silanes, and siloxanes, moisture scavengers and polymerization initiators. In some embodiments, the solution comprises one or more additives.

In some embodiments, the one or more additives are selected from the group consisting of fillers, ultraviolet stabilizers, heat stabilizers, adhesion improvers, antioxidants, radical scavengers, cross linkers, ultraviolet light absorbers, ionic liquids, pigments, dyes, IR absorbers or blockers, surfactants, chelating agents, and impact modifiers. In some embodiments, the one or more additives are selected from the group consisting of reactive adhesion improvers, antioxidants, radical scavengers, cross linkers, ultraviolet light absorbers, Surface Electrolyte Interface (SEI) layer forming compounds.

In some embodiments, the solution comprises an electrolyte solution.

In some embodiments, the solvent comprises a plasticizer. In some embodiments, the plasticizer has an electrochemical window between approximately +1 V to approximately +4 V. In some embodiments, the solvent comprises one or more plasticizers selected from the group consisting of propylene carbonate, ethylene carbonate, diethyl carbonate, sulfolane, tetraglyme, γ-butyrolactone, triethylene glycol bis(2-ethylhexanoate), diethylene glycol butyl ether, diethylene glycol dibutyl ether, dimethyl glutarate, dimethyl 2-methylglutarate, bis(2-butoxyethyl) adipate, dimethyl adipate, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, and cyrene (dihydrolevoglucosenone).

In some embodiments, the property of the prefabricated film that is modified comprises ionic conductivity. In some embodiments, the ionic conductivity of the modified film is at least 20% greater than the ionic conductivity of the prefabricated film as measured via electrochemical impedance spectroscopy. In some embodiments, the prefabricated film does not exhibit ionic conductivity and wherein the modified film does exhibit ionic conductivity sured. In some embodiments, the modified film has an ionic conductivity of at least 1×10⁻⁷ S/cm. In some embodiments, the ionic conductivity is measured via electrochemical impedance spectroscopy.

In some embodiments, the step of exposing comprises one or more of: immersing the prefabricated film in the solvent, a cut sheet method, a dip bin method, a roll to roll through dip bin method, a cut sheet method in combination with a dip bin method, painting, roller, roll-to-roll, slot die coating, and spray coating.

In some embodiments, the treatment period comprises between approximately 1 minute to approximately 24 hours. In some embodiments, the treatment period comprises between approximately 15 minutes to approximately 180 minutes. In some embodiments, the treatment period comprises between approximately 15 minutes to approximately 60 minutes.

In some embodiments, the treatment conditions comprise a temperature of between approximately 10° C. and approximately 70° C. In some embodiments, the treatment conditions comprise a dry atmosphere. In some embodiments, the treatment conditions comprise an inert atmosphere. In some embodiments, the dry atmosphere comprises a dewpoint of less than 0° C. In some embodiments, the inert atmosphere comprises argon.

In some embodiments, the method comprises removing excess solvent after the step of exposing. In some embodiments, removing excess solvent comprises patting with an absorbent material, sparging with dry air, and/or sparging with inert gas. In some embodiments, the method comprises removing excess solution after the step of exposing. In some embodiments, removing excess solution comprises patting with an absorbent material, sparging with dry air, and/or sparging with inert gas.

Another aspect of the invention provides a method to manufacture an ion-conducting polymeric interlayer as described herein.

Another aspect of the invention provides a modified film manufactured according to the methods described herein.

Another aspect of the invention provides a method of manufacturing an electrochromic laminate device, the method comprising a step of incorporating a modified film in the electrochromic laminate device, the modified film manufactured according to the methods described herein.

Another aspect of the invention provides a method of forming an electrochromic laminate device comprising the steps of: providing a first coated substrate, wherein the first coated substrate comprises a first transparent conductive layer and at least a first electrochromic layer; providing a second coated substrate wherein the second coated substrate comprises a second transparent conductive layer and at least a second electrochromic layer; providing an interlayer film; treating the interlayer film according to the methods described herein to form a modified interlayer film; applying the modified interlayer film on the first coated substrate, wherein the modified interlayer film is in contact with at least one electrochromic layer of the first coated substrate; stacking the second glass substrate on the interlayer film opposite the first glass sheet, wherein the modified interlayer film is in contact with at least one electrochromic layer of the second coated substrate, thereby sandwiching the modified interlayer film to form a first assembly; and performing a lamination process comprising subjecting the first assembly to pressure and heat.

In some embodiments, the first coated substrate comprising a first coated glass substrate and the second coated substrate comprises a second coated glass substrate. In some embodiments, the interlayer film comprises a free-standing interlayer film. In some embodiments, the interlayer film comprises an ion-conducting interlayer film. In some embodiments, the interlayer film comprises a polymer interlayer film. In some embodiments, the thickness of the modified interlayer film ranges from approximately 0.100 mm to approximately 2.0 mm. In some embodiments, the thickness of the modified interlayer film ranges from approximately 0.15 mm to approximately 1.55 mm. In some embodiments, the modified interlayer film is transparent after lamination. In some embodiments, the method comprises applying busbars. In some embodiments, the method comprises applying a sealant material around the perimeter of the modified interlayer film wherein the sealant is in contact with at least one of the conductive layer and at least one electrochromic layer of the first coated substrate. In some embodiments, the electrochromic laminate device is subsequently incorporated into an insulated glass unit (IGU).

Another aspect of the invention provides method of making an electrochemical cell, the method comprising incorporating a modified film manufactured using the method according to any of the methods described herein into the electrochemical cell, wherein the electrochemical cell optionally comprises a battery, a capacitor or a supercapacitor, wherein the battery is optionally a lithium ion battery or a sodium ion battery.

Another aspect of the invention provides a method of forming an electrochromic laminate device. The method comprises the steps of: providing a first coated substrate wherein the first coated substrate comprises a first transparent conductive layer and at least a first electrochromic layer; providing a second coated substrate wherein the second coated substrate comprises a second transparent conductive layer and at least a second electrochromic layer; providing an interlayer film, wherein the interlayer film is treated to increase its ionic conductivity by exposing the interlayer film to a solvent to make a modified interlayer film; applying the modified interlayer film on the first coated substrate, wherein the modified interlayer film is in contact with at least one electrochromic layer of the first coated substrate; stacking the second glass substrate on the interlayer film opposite the first glass sheet, wherein the modified interlayer film is in contact with at least one electrochromic layer of the second coated substrate, thereby sandwiching the modified interlayer film to form a first assembly; and performing a lamination process comprising subjecting the first assembly to pressure and heat.

In some embodiments, the first coated substrate comprising a first coated glass substrate and the second coated substrate comprises a second coated glass substrate. In some embodiments, the interlayer film comprises a free-standing interlayer film. In some embodiments, the interlayer film comprises an ion-conducting interlayer film. In some embodiments, the interlayer film comprises a polymer interlayer film. In some embodiments, the thickness of the modified interlayer film ranges from approximately 0.100 mm to approximately 2.0 mm. In some embodiments, the thickness of the modified interlayer film ranges from approximately 0.15 mm to approximately 1.55 mm. In some embodiments, the modified interlayer film is transparent after lamination. In some embodiments, the method comprises applying busbars. In some embodiments, the method comprises applying a sealant material around the perimeter of the modified interlayer film wherein the sealant is in contact with at least one of the conductive layer and at least one electrochromic layer of the first coated substrate. In some embodiments, the electrochromic laminate device is subsequently incorporated into an insulated glass unit (IGU).

### BRIEF DESCRIPTION OF THE DRAWINGS

The specific arrangements shown in the Figures should not be viewed as limiting. It should be understood that the illustrated elements, including and the shape, size and scale, are not drawn in actual proportion to each other.

Further features and advantages of the present disclosure will become apparent from the following detailed description, taken in combination with the appended drawings, in which:

FIG. 1 illustrates an example embodiment of a prior art electrochromic device having a multi-layer structure formed using two substrates.

FIG. 2 shows an example embodiment of a method for modifying a property of a prefabricated film according to an example embodiment of the invention.

FIGS. 3A, 3B and 3C show an example embodiment of a prefabricated film being modified according to an example embodiment of the invention.

FIG. 5 shows an example embodiment of a method for fabricating an electrochromic device according to an example embodiment of the invention.

FIG. 5 shows an example embodiment of an electrochromic device having a multi-layer structure formed using two substrates and containing a modified film as disclosed herein.

FIG. 6 shows five switching cycles for an exemplary electrochromic device incorporating a polymeric film according to an example embodiment.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and not limited to just one.

Unless defined otherwise, all technical and scientific terms used herein have the same meaning as commonly understood by one of ordinary skill in the art to which this invention belongs.

The present disclosure describes processes to introduce ionic conductivity to free standing prefabricated films (e.g., polymer films) and to increase the ionic conductivity of free standing prefabricated films (e.g., polymer films), and/or add a reactive component post film fabrication. This permits the extrusion (or another technique known by those skilled in the art) to occur at one time and/or location to manufacture a prefabricated film, and allows the resulting product to be stored and/or shipped to another location before modification of the film to increase the ionic conductivity. During shipping, the material may be in foiled lined bags to prevent evaporation of plasticizer(s), absorption of water and reaction with air.

One aspect of the invention provides a method for modifying a property of a prefabricated film. At a first step, a prefabricated film is provided. At a second step, the prefabricated film is exposed to a solvent to modify a property of the prefabricated film during a treatment period and under treatment conditions to yield a modified film. In some embodiments, the solvent comprises a plasticizer. In some embodiments, the solvent is part of a solution. In some embodiments, the solution comprises one or more reactive compounds. In some embodiments, the solvent comprises a plasticizer and the reactive compound comprises a salt that together form the solution (e.g., an electrolyte solution). In some embodiments, additional additives are incorporated into the solvent or the solution. The film is exposed to the solvent (e.g., as part of the solution in some embodiments) for a treatment period under treatment conditions to yield a modified film that has been imbued with the solvent and, in embodiments in which a reactive compound is present, with the reactive compound, and, in embodiments in which one or more additives are present, with the additive(s). At a third step, the solvent or solution that is not absorbed into the modified film is removed from the resultant modified film (e.g., via evaporation of the solvent or solution as a vapor).

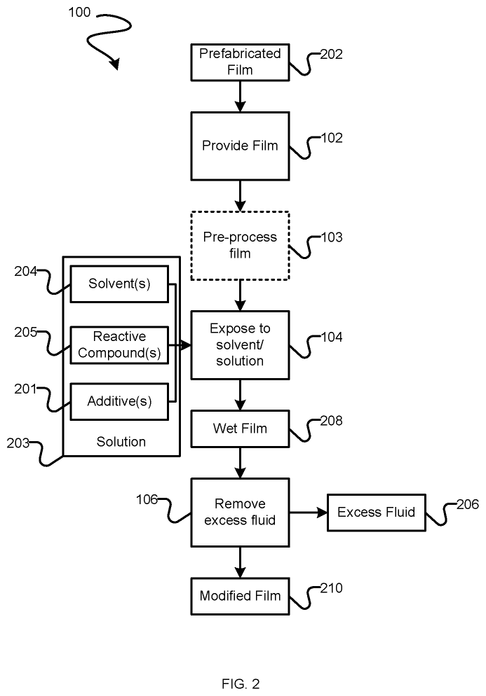

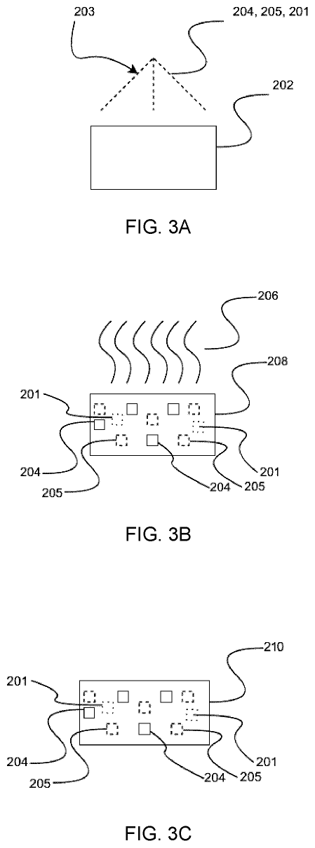

FIG. 2 illustrates an example embodiment of a method 100 for modifying a property of a prefabricated film 202. The output of method 100 is a modified film 210. FIGS. 3A, 3B and 3C schematically illustrate an example embodiment of a prefabricated film 202 being subjected to method 100.

In some embodiments, step 102 of method 100 comprises providing a prefabricated film 202. As used herein, the term “prefabricated” refers to something that has been manufactured at an earlier time and/or by a different (e.g., standalone) process. This may be at a different location although this is not mandatory. For example, a prefabricated film may be a film that was fabricated prior to treatment using the methods and/or processes described herein.

Prefabricated film 202 may comprise a free standing film. As used herein, the term “free standing film” refers to a film, a part of which is not in contact with a support material such as a substrate.

Prefabricated film 202 may comprise a prefabricated polymer film. As used herein, the term “polymer” includes, but is not limited to, organic homopolymers, copolymers, such as for example, block, graft, random and alternating copolymers, terpolymers, etc., and blends and modifications thereof.

In some embodiments, prefabricated film 202 is selected from at least one of a polyvinyl butyral (PVB), a thermoplastic polyurethane (TPU), aliphatic polyurethane, polyether polyurethane, aliphatic polyurethane, a polyether, an ethylene vinyl acetate (EVA), a polyol, and an ionomer polymer material.

Prefabricated film 202 may be made by any suitable method such as, for example, extrusion, cast film, blown film or other methods now known to those skilled in the art or later developed.

In some embodiments, a thickness of prefabricated film 202 is selected to assist in achieving the desired properties of a resultant modified film 210 produced by method 100. For example, in some embodiments, the thickness of prefabricated film 202 is between approximately 0.05 mm and 4 mm including any value therebetween (e.g., 0.10, 0.25, 0.50, 0.75, 1.0, 1.5, 2.0, 2.5, 3.0 or 3.5 mm). Many applications may use films having a thickness of between approximately 0.15 mm and approximately 1.55 mm. Normally the thinnest possible film suitable for a particular application is used. However material handling constraints and end-product characteristics may mean that slightly thicker films may be used. For example sufficient thickness of window films is required to overcome the roller-wave and edge-kink non-uniformity when laminating tempered glass. In some embodiments, a plurality of sheets of modified film 210 may be combined together and laminated to form a film having a desired thickness.

In some embodiments, prefabricated film 202 is subjected to a desired surface treatment at optional step 103 (e.g., prior to step 104). For example, in some embodiments, at optional step 103, micropores and/or nanopores may be generated in or on one or both broad surfaces of prefabricated film 202. In some embodiments, the micropores and/or nanopores reduce the density of prefabricated film 202 by approximately 0% to approximately 50%, including any value or subrange therebetween (e.g., 5%, 10%, 15%, 20%, 25%, 30%, 35%, 40% or 45%). Without being bound by theory, such surface treatments may enhance the penetration into prefabricated film 202 of solvent 204 or solution 203 and any reactive compound(s) 205 or additive(s) 201 dissolved in solution 203 at step 104.

In some embodiments, step 104 of method 100 comprises exposing prefabricated film 202 to a solvent 204 to form a wet modified film 208 as shown schematically, for example, in FIG. 3A. Solvent 204 may comprise a plasticizer, but this is not mandatory. Solvent 204 may be part of a solution 203. Solution 203 may comprise an electrolyte solution. In some embodiments, such as shown in FIGS. 3A, 3B and 3C, solution 203 optionally contains one or more reactive compounds 205. In some embodiments, additional additives 201 are incorporated into solution 203.

In some embodiments, at step 104, the ionic conductivity of prefabricated film 202 is increased by exposing (e.g., immersing) prefabricated film 202 to a solution 203 comprising a solvent 204 comprising one or more plasticizers and a reactive compound 205 comprising one or more alkali metal salts. In some embodiments, at step 104, prefabricated film 202 is exposed to salt as reactive compound 205 and plasticizer as solvent 204 (together forming solution 203) in an amount sufficient to impart high ionic strength to the resultant modified film 210. The conducting ions are most typically lithium ions along with a suitable counter ion, but many mobile ion pairs are known to those with ordinary skill in the art and can be used in various embodiments.

In alternative embodiments, solution 203 comprises one or more reactive compounds 205 and a solvent 204 that is not a plasticizer (e.g., in cases where it is not desired to incorporate a plasticizer into prefabricated film 202 in addition to the one or more reactive compounds 205). In other words, certain embodiments are not limited to using a plasticizer as solvent 204 but can instead use any suitable solvent in solution 203 to introduce reactive compounds 205 into the prefabricated film 202 to produce modified film 210.

As used herein, the term “reactive compound” refers to a compound that is reactive with air, oxygen, carbon dioxide, or water or humidity. Examples of reactive compounds include alkali metals, alkali metal salts, silanes, and siloxanes, moisture scavengers and polymerization initiators. In some embodiments, reactive compound 205 comprises one or more salts. In some embodiments, reactive compound 205 comprises one or more alkali metal salts selected from a lithium salt, a sodium salt, and a potassium salt. In some embodiments, reactive compound 205 comprises one or more lithium salts selected from lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato) borate, lithium difluoro (oxalato) borate, and lithium 4,5-dicyano-2-(trifluoromethyl) imidazol-1-ide.

In some embodiments, the concentration of alkali metal salt as reactive compound 205 in solution 203 is from approximately 0.2 M to approximately 2 M, including any value or subrange therebetween (e.g., 0.4, 0.6, 0.8, 1.0, 1.2, 1.4, 1.6 or 1.8 M), and optionally from approximately 0.8 M to approximately 1.6 M.

As used herein, the term “plasticizer” refers to the liquid component or mixture of liquid components comprising a portion of the polymer electrolyte. The combination of liquid phases, including a dielectric plasticizer component plus any other liquids, added to the polymer electrolyte formulation are referred collectively herein as the plasticizer(s). In some embodiments, solvent 204 comprises a plasticizer. In some embodiments, solvent 204 comprises a dielectric plasticizer. In some embodiments, solvent 204 comprises one or more plasticizers selected from propylene carbonate, ethylene carbonate, diethyl carbonate, sulfolane, tetraglyme, γ-butyrolactone, triethylene glycol bis(2-ethylhexanoate), diethylene glycol butyl ether, diethylene glycol dibutyl ether, dimethyl glutarate, dimethyl 2-methylglutarate, bis(2-butoxyethyl) adipate, dimethyl adipate, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, cyrene (dihydrolevoglucosenone), and combinations thereof.

In some embodiments, solvent 204 may comprise other plasticizers and their mixtures wherein the resulting solution 203 provides the appropriate salt solubility and clarity to the as required for the desired application.

In certain embodiments, at least one of the plasticizers used as solvent 204 has a reasonably large electrochemical window if being used in an application such as an electrochromic window. The desired electrochemical window may vary depending on the particular application, but as an example, an electrochemical window of from approximately +1 V to approximately +4 V versus lithium metal is an acceptable value for many applications.

In some embodiments, solution 203 may comprise one or more additives 201 such that additives 201 may be incorporated into prefabricated film 202 at step 104. In some embodiments, additives 201 may enhance performance or durability of the resultant modified film 210. Additives 201 may include, but are not limited to, fillers, ultraviolet stabilizers, heat stabilizers, adhesion improvers, antioxidants, radical scavengers, cross linkers, ultraviolet light absorbers, ionic liquids, pigments, dyes, IR absorbers or blockers, surfactants, chelating agents, and impact modifiers, in addition to other additives known to those skilled in the art. In some embodiments, additives 201 are reactive. Reactive additives 201 may include, but are not limited to, reactive adhesion improvers, antioxidants, radical scavengers, cross linkers, ultraviolet light absorbers, Surface Electrolyte Interface (SEI) layer forming compounds and the like. Examples of other additives 201 that are not reactive species but which may be incorporated as additives 201 in various embodiments include fillers, ultraviolet stabilizers, heat stabilizers, ultraviolet light absorbers, ionic liquids, pigments, dyes, IR absorbers or blockers, surfactants, chelating agents, impact modifiers and the like.

Any suitable technique may be employed to expose prefabricated film 202 to the solvent 204 (or solution 203, as the case may be) at step 104. For example, prefabricated film 202 may be exposed to solvent 204 (or solution 203, as the case may be) by:
a cut sheet method (i.e. soaking the film in the solvent 204 or solution 203 after the film has been cut to size for a particular application);
a “roll to roll through dip bin” method;
a dip bin method;
a combination of the cut sheet method with a dip bin method;
immersion of film 202 in solvent 204 (or in solution 203, as the case may be);
adding a known volume of solvent 204 (or solution 203, as the case may be) to prefabricated film 202;
application of solvent 204 (or solution 203, as the case may be) by painting, a roller, spray coating, slot die coating, or any other suitable coating method;
a roll-to-roll process; and/or.
any other suitable method now known in the art or later developed.
   Preferably the process used to expose prefabricated film 202 to solvent 204 (or solution 203, as the case may be) at step 104 permits a uniform uptake of solvent 204, present reactive compounds 205 and/or present additives 201 in order to yield consistent properties across the entire area of the resultant modified film 210.

The duration of the treatment (e.g., exposure of prefabricated film 202 to solvent 204 or solution 203) at step 104 and/or the characteristics of the treatment conditions at step 104 may be controlled to provide a resultant modified film 210 with desired material properties. For example, prefabricated film 202 may lose its structural integrity if the treatment duration is too long, or if the treatment is carried out in a solvent 204 (or solution 203) in which prefabricated film 202 is highly soluble.

In some embodiments, the duration for which solvent 204 (or solution 203, as the case may be) is in contact with prefabricated film 202 at step 104 is from approximately 1 minute to approximately 24 hours, including any value or subrange therebetween (e.g., 2, 3, 4, 5, 6, 7, 8, 9, 10, 11, 12, 13, 14, 15, 16, 17, 18, 19, 20, 22, 24, 26, 28, 30, 35, 40, 45, 50, 55 or 60 minutes, or 1.5, 2.5, 3.0, 3.5, 4.5, 5, 6, 7, 8, 9, 10, 12, 14, 16, 18, 20 or 22 hours). In some embodiments, solvent 204 (or solution 203, as the case may be) is in contact with the prefabricated film 202 for a treatment period of from approximately 15 minutes to approximately 180 minutes. In some embodiments, solvent 204 (or solution 203, as the case may be) is in contact with the prefabricated film 202 for a treatment period of from approximately 15 minutes to approximately 60 minutes.

In some embodiments, the treatment conditions comprise a temperature in the range of between approximately 10° C. and approximately 70° C. including any value or subrange therebetween (e.g., 15, 20, 25, 30, 35, 40, 45, 50, 55, 60, or 65° C.). In some embodiments, the treatment conditions comprise ambient temperature.

In some embodiments, the treatment conditions comprise a dry and/or inert atmosphere, for example an argon or nitrogen atmosphere and/or a dry room. In some embodiments, a dry atmosphere has a dewpoint that is between 0 C and −40 C or lower, including any value or subrange therebetween (e.g., −5, −10, −15, −20, −25, −30 or −35 C).

In some embodiments, the treatment conditions comprise a pressurized atmosphere. For example, in some embodiments, the treatment conditions comprise a pressure of between approximately 1 bar and 14 bar, including any value or subrange therebetween (e.g., 2, 3, 4, 5, 6, 7, 8, 9, 10, 11, 12, 13 or 14 bar).

In some embodiments, step 104 is conducted in a suitable environment, machine or device to achieve the desired treatment conditions. For example, step 104 can be conducted in an autoclave or other suitable environment that can be heated, cooled and/or pressurized in embodiments in which the treatment conditions include elevated or reduced temperature or elevated pressure.

Step 106 may comprise removing excess fluid 206 (e.g., excess solvent 204 and/or excess solution 203 or components thereof) from wet modified film 208 (as shown schematically, for example, in FIG. 3B) to form modified film 210 (as shown schematically, for example, in FIG. 3C). For example, after wet modified film 208 is removed from being immersed in solution 203 at step 104, wet modified film 208 may still be covered, at least in part, by some excess fluid 206 (e.g., excess solvent 204 and/or excess solution 203 or components thereof). In some embodiments, excess fluid 206 is removed by patting wet modified film 208 with absorbent material, squeegeeing off excess fluid 206, sparging with dry air or sparging with inert gas. In some embodiments, excess fluid 206 is merely allowed to evaporate. Other methods known to those skilled in the art are equally applicable to remove excess fluid 206 at step 106. During step 106, despite at least some excess fluid 206 being removed from wet modified film 208, the resultant modified film 210 may still be imbued with (or incorporate), at least in part, solution 203, solvent(s) 204 (e.g., plasticizers), reactive compound(s) 205 (e.g., metal salts) and/or additive(s) 201.

In some embodiments, step 106 may not be necessary and step 104 may directly output modified film 210.

In some embodiments, the treatment period and/or treatment conditions at step 104 (and optional step 106) are selected to yield desired properties of the resultant modified film 210. In some embodiments, carrying out of method 100 can result in the enhancement of some properties of modified film 210 (e.g., ionic conductivity), while producing a corresponding decrease in some properties of prefabricated film 202 (e.g., mechanical strength). Thus, as noted above, the parameters of the treatment period and/or the treatment conditions can be selected to achieve a desired balance between the enhancement of some properties (e.g., the ionic conductivity of modified film 210) and the degradation of other properties (e.g., the mechanical strength of modified film 210). Other parameters such as the material from which prefabricated film 202 is made, its thickness and mode of manufacture, any preparatory treatment of prefabricated film 202 (e.g., at step 103), the choice of solvent 204, and so on can also impact the final properties of the modified film 210.

In some embodiments, modified film 210 meets predetermined conductivity requirements. For example, in some embodiments, the modified film 210 has an ionic conductivity that is at least 1×10⁻⁶ S/cm, including at least 1×10⁻⁵ S/cm, and an electrical conductivity that is less than 1×10⁻¹⁰ S/cm, including less than 1×10⁻¹¹ or 1×10⁻¹² S/cm as measured at room temperature (i.e. at 20 degrees C.). In some embodiments, modified film 210 has an ionic conductivity that is between 2 and 10 times higher than the prefabricated film 202. In some embodiments, the modified film 210 has an ionic conductivity that is at least 20% higher than the prefabricated film 202, including at least 25%, 30%, 40%, 50%, 75%, 100%, 200%, 300%, 400%, 500%, 750%, 1000%, 1500%, 2000%, 2500% or 3000% higher than prefabricated film 202. In some embodiments, modified film 210 exhibits ionic conductivity while prefabricated film 202 does not exhibit ionic conductivity (e.g., prefabricated film 202 exhibits no measurable ionic conductivity using, for example, electrochemical impedance spectroscopy). In some such embodiments, modified film 210 exhibits an ionic conductivity of at least 1×10⁻⁷ S/cm, including, for example, at least 1×10⁻⁶ or 1×10⁻⁵ S/cm or 3×10⁻⁵ S/cm (e.g., using electrochemical impedance spectroscopy).

In some such embodiments, the ionic conductivity of both prefabricated film 202 and modified film 210 is measured using electrochemical impedance spectroscopy. Exemplary methods of employing electrochemical impedance spectroscopy to determine ionic conductivity are described, for example in “Electrical and electrochemical studies on sodium ion-based gel polymer electrolytes” (AIP Conference Proceedings 1877, 040001 (2017), doi.org/10.1063/1.4999867) and “Electrochemical Impedance Spectroscopy for All-Solid-State Batteries: Theory, Methods and Future Outlook” (P. Vadhva, J. Hu, M. J. Johnson, R. Stocker, M. Braglia, D. J. L. Brett, A. J. E. Rettie, ChemElectroChem 2021, 8, 1930-1947, doi.org/10.1002/celc.202100108). In the examples described herein, the ionic conductivity of the film (laminated between two identical TCO electrodes), was measured by potentiostatic electrochemical impedance spectroscopy using a WaveDriver 100 EIS potentiostat/galvanostat at room temperature. The AC amplitude was set at 10 mV, and the frequency range was between 1 MHz and 1 Hz. The resulting Nyquist plot was fitted with an appropriate Kramers-Kronig circuit network, or an equivalent simplified model, to determine the total resistance (R) in ohms. Finally, the ionic conductivity was calculated using the formula conductivity=1/(resistance×area).

In some embodiments, the modified film 210 meets predetermined strength or physical property requirements. For example, in some embodiments, modified film 210 retains sufficient mechanical strength after method 100 to allow polymeric film 210 to be removed from a release liner during manufacture of an electrochemical device in embodiments where prefabricated film 202 is exposed to solvent 204 (or solution 203, as the case may be) with a release liner. In some embodiments, modified film 210 has mechanical properties that are suitable for use in the intended application of the film.

In some embodiments, modified film 210 has a thickness that is between approximately 0.05 mm and 4 mm including any value therebetween (e.g., 0.10, 0.25, 0.50, 0.75, 1.0, 1.5, 2.0, 2.5, 3.0 or 3.5 mm). Many applications may use films having a thickness of between approximately 0.15 mm and approximately 1.55 mm. Normally the thinnest possible film suitable for a particular application is used; however material handling constraints and end-product characteristics may mean that slightly thicker films may be used. For example sufficient thickness of window films is required to overcome the roller-wave and edge-kink non-uniformity when laminating tempered glass. In some embodiments, a plurality of sheets of modified film 210 may be combined together and laminated to form a film having a desired thickness.

By employing method 100, extrusion of prefabricated film 202 can be carried out at a higher solids content than would normally be the case for films intended to be directly incorporated into electrochemical devices since prefabricated film 202 can subsequently be modified by method 100 to have properties suitable for the desired electrochemical device application. Thus, use of methods such as method 100 to modify one or more properties of prefabricated film 202 can enable simpler and/or less expensive film manufacturing techniques to be used as compared to attempting to extrude films for direct use in electrochemical devices (e.g., since extrusion of high liquid content films is difficult).

It can be advantageous to add reactive compound(s) 205 by method 100 and therefore manufacture prefabricated film 202 without initially incorporating reactive compound(s) 205 as reactive compound(s) 205 (e.g., lithium) may be difficult to incorporate into a polymeric film at the time of manufacture and/or may be degraded through storage and exposure to the atmosphere.

Introduction of reactive compound(s) 205 (e.g., lithium) at a later time than the initial manufacture of prefabricated film 202 through the use of method 100 may also allow a second reactive compound 205 (e.g., a more reactive lithium salt) to be introduced into prefabricated film 202, and/or allow another more reactive compound 205 (e.g., a moisture scavenger or the like) to be introduced at a later time. Further, the use of method 100 may allow any plasticizer that is lost (e.g., during handling, storage and/or transport) to be re-introduced (e.g., as solvent 204) and/or may allow any reactive compound 205 (e.g., lithium) that reacted during handling, storage and/or transport (e.g., via reactions with carbon dioxide or water) to be re-introduced into the final modified film product 210 by method 100.

Method 100 may also allow the use of inexpensive commercially available polymer films (e.g., thermoplastic polyurethane (TPU), polyvinyl butyral (PVB), ethylene vinyl acetate (EVA), or the like) to be used as prefabricated film 202 to manufacture electrochemical devices that would otherwise typically incorporate more expensive specialized polymer films.

Another aspect of the invention provides methods for fabricating electrochromic windows. In some embodiments, modified films (e.g., modified films 210) made using methods disclosed herein (e.g., method 100) may be incorporated into electrochromic windows. In certain embodiments such as, for example, embodiments where a modified film made according to methods disclosed herein will be incorporated into electrochromic windows, the free-standing film is laminated (subjected to heat and pressure) with other components to produce the desired electrochromic window product. For example, the free-standing modified film can be subjected to a pressure of between 1 bar and 14 bar, such as approximately 12.4 bar, 5 bar or 7 bar, at a temperature of between 80° C. and 185° C. during lamination for a time period of between for example 1 second and 2 hours, such as for approximately 30 seconds, 10 minutes, 30 minutes, 60 minutes or 120 minutes, with the direction of the pressure being essentially at both sides of the extended surface area perpendicular to the extended surface, and a laminated film is subsequently obtained. For example, such a laminated structure is obtainable by adhering the modified film at both sides of the film surface to a material suitable for incorporation into an electrochromic window, for example, by sandwiching the modified film in between two sheets of such material. Such materials are known in the art, and examples include, but are not limited to glass, polyethylene terephthalate (PET), polycarbonate, polyethylene naphthalate (PEN), polyvinyl butyral (PVB), polymethyl methacrylate (PMMA), acrylic, and polyvinyl chloride (PVC), such as a pane of glass and a sheet of polycarbonate.

According to some embodiments of the invention, there is further provided an associated method for making an electrochemical device whose electrolyte is made via one of the aforementioned processes (e.g., method 100). Here, the electrochemical device generally includes a first substrate-supported electrode, a second substrate-supported electrode, and an ion-conductive electrolyte layer which separates and is in physical contact with the first substrate-supported electrode and the second substrate-supported electrode, wherein the electrolyte layer is a free-standing modified film whose ionic conductivity was increased through methods disclosed herein (e.g., method 100). The electrochemical device may be a battery (including a lithium ion battery or a sodium ion battery), electrochromic window, capacitor or supercapacitor, or the like.

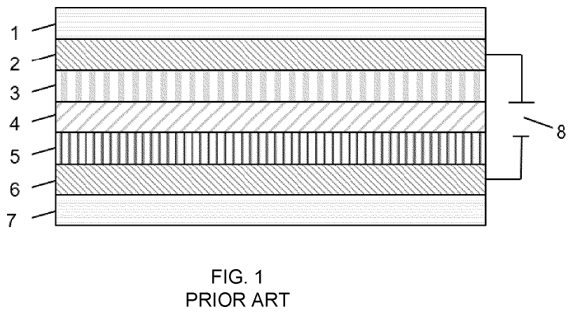

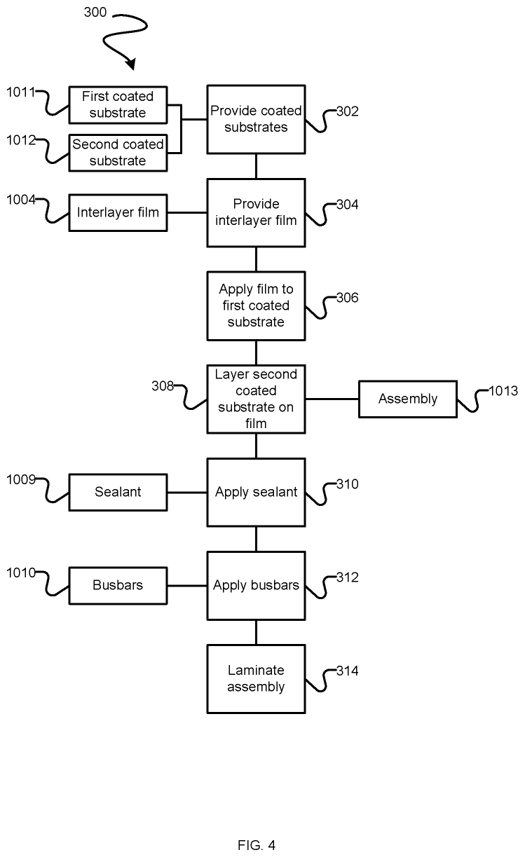

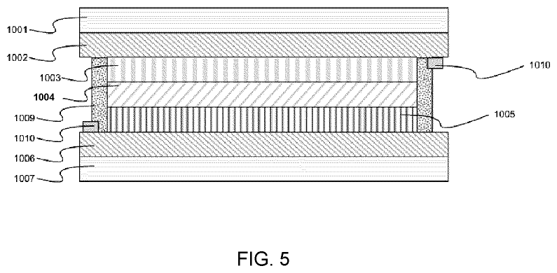

In accordance with an aspect of the present invention, there is provided a method of forming a laminated electrochromic device. The laminated electrochromic device may comprise, for example, an electrochromic window. FIG. 4 illustrates an example embodiment of a method 300 of forming a laminated electrochromic device. FIG. 5 schematically depicts the multilayer architecture of an electrochromic device that can be prepared using the methods of the present invention (e.g., method 300). The device of FIG. has similarities to the device illustrated in FIG. 1, and like components have been illustrated with reference numerals incremented by 1000.

Method 300 may comprise a step 302 of providing a first coated substrate 1011 and a second coated substrate 1012. First coated substrate 1011 may comprise a first substrate 1001 (e.g., a glass substrate), a first transparent conductive layer 1002 and at least a first electrochromic layer 1003 (e.g., an anodic electrochromic layer). Second coated substrate 1012 may comprise a second substrate 1007 (e.g., a glass substrate), a second transparent conductive layer 1006 and at least a second electrochromic layer 1005 (e.g., a cathodic electrochromic layer). The substrates 1001, 1007 provide a base structure for the active device materials and protection for the internal layers. The electrically-conductive layers 1002, 1006 provide a means for conducting charge to and from the electrochromic layers 1003, 1005 from an external power source and/or control electronics and software.

Substrates 1001, 1007 may comprise any suitable material known in the art, such as, for example, glass, polyethylene terephthalate (PET), polycarbonate, polyethylene naphthalate (PEN), polyvinyl butyral (PVB), polymethyl methacrylate (PMMA), acrylic, and polyvinyl chloride (PVC), such as a pane of glass and a sheet of polycarbonate.

First and second electrochromic layers 1003, 1005 may comprise transition metal oxides, transition metal complexes, conducting polymers, viologens, or the like. In other cases, organic dyes, such as viologens and phenazines may be used as the electrochromic moieties.

In some embodiments, one of first and second electrochromic layers 1003, 1005 may be replaced with an ion-storage layer. Common cathodic electrochromic materials include tungsten oxide (WOx), molybdenum oxide (“MoOx”), titanium oxide (TiOx), tantalum oxide (TaOx) and niobium oxide (NbOx) doped tungsten oxide. Known anodic electrochromic materials are nickel oxide (NiOx), vanadium oxide (VOx), and iridium oxide (IrOx). Materials such as cobalt oxide (CoOx), manganese oxide (MnOx) and iron oxide (FeOx) have also been shown to exhibit electrochromic behaviour, but are not ideal as they do not bleach completely. First and second electrochromic layers 1003, 1005 are not necessarily a single material, but may comprise a mixture of the above materials. Suitable dopants may be included in the material composition of the first and second electrochromic layers 1003, 1005.

Method 300 may continue at step 304 with providing an interlayer film 1004. Interlayer film 1004 may comprise, for example, a free-standing ion-conducting polymer interlayer film. Interlayer film 1004 may be treated to increase its ionic conductivity to produce a modified film as described in this disclosure. Interlayer film 1004 may comprise modified film 210 (in other words, interlayer film 1004 may be fabricated or modified according to method 100). In some embodiments, method 100 may occur at step 304 to thereby provide interlayer film 1004 (e.g., where interlayer film 1004 comprises modified film 210 output from method 100). In some embodiments, a thickness of interlayer film 1004 is between approximately 0.100 mm and 2.0 mm. In some embodiments, a thickness of interlayer film 1004 is between approximately 0.15 mm and 1.55 mm.

Method 300 may continue at step 306 with applying or layering interlayer film 1004 on first coated substrate 1011 such that interlayer film 1004. Interlayer film 1004 may be arranged such that it is in contact with at least one electrochromic layer 1003 of first coated substrate 1011. Interlayer film 1004 provides a means to transport ions between the anodic electrochromic layer 1003 and cathodic electrochromic layer 1005.

Method 300 may continue at step 308 with applying or layering second coated substrate 1012 on interlayer film 1004 opposite first coated substrate 1011. Interlayer film 1004 may be arranged such that interlayer film 1004 is in contact with at least one electrochromic layer 1005 of second coated substrate 1012 thereby sandwiching interlayer film 1004 to form a first assembly 1013.

At step 310, a sealant material 1009 may be applied around the perimeter of the interlayer film 1004. Sealant material 1009 may be arranged to be in contact with one or more of first conductive layer 1002, first electrochromic layer 2003, interlayer 1004, second electrochromic layer 1005 and second conductive layer 1006, such as is shown schematically in FIG. 5. Any suitable edge sealant 1009 can be applied as sealant 1009 to avoid reaction of moisture, carbon dioxide and/or oxygen present in the atmosphere with the components of the electrochromic device, for example as described in U.S. Pat. No. 10,948,795.

At step 312 one or more busbars 1010 may be applied to each electrode to facilitate electrical charge transfer to the electrically conductive substrate and/or a pigtail may be provided to allow connection of an electrical supply to the conductive glass substrates. Busbars 1010 may be applied prior to the edge sealant, and can be encapsulated by the sealant. In some embodiments, step 312 may occur after step 314.

At step 314, a lamination process may be performed comprising subjecting assembly 1013 to pressure and heat. The pressure and/or heat may be sufficient to deair interlayer film 1004. The pressure and/or heat may be sufficient so that sealant 1009 and interlayer film 1004 adhere to first and second coated substrates 1011, 1012.

It is within the scope of the present invention that the order of the layers may be reversed with respect to the substrate. That is, the layers can be in the following order: first substrate, first transparent conductive layer, cathodic electrochromic layer, electrolyte layer, anodic electrochromic layer or ion-storage layer, second transparent conductive layer, and second substrate. It is also within the scope of the present invention that additional protective and functional layer(s) may also optionally be applied. The thickness of the layers of the device, including and the shape, size and scale of layers is not drawn to scale or in actual proportion to each other, but is represented for clarity.

Electrochromic devices fabricated by method 300 may be used for a variety of applications, for example automotive mirrors, sunroofs, energy efficient glazing for buildings, and skylights, among others. The electrochromic device may be incorporated into insulating glass units (IGUs).

The invention will now be described with reference to specific examples, the results of which are summarized in Table 1. It will be understood that the following examples are intended to describe embodiments of the invention and are not intended to limit the invention in any way. It will be understood that certain aspects of the disclosed processes can be arranged and combined in a wide variety of different configurations, all of which are contemplated herein.

### EXAMPLES

TABLE 1
Summary of Data from Examples.

| | | | | Ratio | |
|---|---|---|---|---|---|
| | | | | of ionic | |
| | | | Ionic | conduc- | |
| | Ionic | | conduc- | tivity | |
| | conduc- | Soak Solvent | tivity | post- | |
| | tivity | (15 min in | post soak | to pre- | % |
| Film | (S/cm) | glovebox) | (S/cm) | soak | increase |
| Conductive | 9.2E−07 | Citroflex C-2 | 1.14E−06 | 1.24 | 24% |
| TPU film 1 | | γ-butyrolactone | 4.81E−06 | 5.23 | 423% |
| | | Sulfolane | 2.70E−06 | 2.93 | 193% |
| Conductive | 1.42E−06 | γ-butyrolactone | 1.22E−05 | 8.59 | 759% |
| TPU film 2 | | PC | 2.03E−06 | 1.43 | 43% |
| Conductive | 1.06E−06 | Citroflex C-2 | 5.63E−06 | 5.31 | 431% |
| TPU film 3 | | γ-butyrolactone | 3.80E−05 | 35.85 | 3485% |
| | | PC | 7.30E−06 | 6.89 | 589% |
| | | Sulfolane | 3.41E−06 | 3.22 | 222% |
| Non- | Unable to | γ-butyrolactone | 3.08E−05 | N/A | N/A |
| conductive | obtain | PC | 1.36E−06 | N/A | N/A |
| PVB film 4 | measure- | | | | |
| | ment | | | | |
| Non- | Unable to | γ-butyrolactone | 1.60E−07 | N/A | N/A |
| conductive | obtain | PC | 1.00E−06 | N/A | N/A |
| TPU film 5 | measure- | | | | |
| | ment | | | | |

### Methods

In the examples below, the ionic conductivity of film (laminated between two identical TCO electrodes) was measured by potentiostatic electrochemical impedance spectroscopy using a WaveDriver 100 EIS potentiostat/galvanostat at room temperature. The AC amplitude was set at 10 mV, and the frequency range was between 1 MHz and 1 Hz. The resulting Nyquist plot was fitted with an appropriate Kramers-Kronig circuit network, or an equivalent simplified model, to determine the total resistance (R) in ohms. Finally, the ionic conductivity was calculated using the formula conductivity=1/(resistance×area).

### Example 1

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 1 was treated (in this case, the film was soaked) for 15 minutes in Citroflex C-2 (Vertellus, Indianapolis, Indiana, United States, a triethyl citrate plasticizer having CAS number 77-93-0 and the molecular formula C₁₂H₂₀O₇) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset from the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of the electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 1.14E-06 S/cm.

### Example 2

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 1 was treated (in this case the film was soaked) for 15 minutes in γ-butyrolactone (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset from the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 4.81E-06 S/cm.

### Example 3

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 1 was treated (in this case the film was soaked) for 15 minutes in sulfolane (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 2.70E-06 S/cm.

### Comparative Example for Example 1, 2 and 3

In this comparative example, fluorine-doped tin oxide (FTO) coated glass substrates (TEC 10; 10/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 1 was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the interlayer, and slightly offset on one edge from the first FTO piece. The pieces were arranged so that the FTO sides were in contact with the interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film was determined to be 9.2E-07 S/cm.

### Example 4

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 2 was treated (in this case the film was soaked) for 15 minutes in γ-butyrolactone (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 1.22E-05 S/cm.

### Example 5

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 2 was treated (in this case, the film was soaked) for 15 minutes in anhydrous propylene carbonate (PC) (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 2.03E-06 S/cm.

### Comparative Example for Example 4 and 5

In this comparative example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 2 was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the interlayer, and slightly offset on one edge from the first FTO piece. The pieces were arranged so that the FTO sides were in contact with the interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film was determined to be 1.42E-06 S/cm

### Example 6

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 3 was treated (in this case the film was soaked) for 15 minutes in Citroflex C-2 (Vertellus, Indianapolis, Indiana, United States) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack is then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 5.63E-06 S/cm.

### Example 7

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 3 was treated (in this case the film was soaked) for 15 minutes in γ-butyrolactone (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 3.80E-05 S/cm.

### Example 8

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 3 was treated (in this case the film was soaked) for 15 minutes in anhydrous propylene carbonate (PC) (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of cleaned fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The soaked interlayer film was placed onto the center of the edge sealed area with approximately a 0.5 mm gap between the treated interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of on the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 7.30E-06 S/cm.

### Example 9

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 3 was treated (in this case the film was soaked) for 15 minutes in sulfolane (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 3.41E-06 S/cm.

### Comparative Example for Example 6, 7, 8, and 9

In this comparative example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of conductive TPU film 3 was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the interlayer, and slightly offset on one edge from the first FTO piece. The pieces were arranged so that the FTO sides were in contact with the interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film was determined to be 1.06E-06 S/cm.

### Example 10

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of non-conductive PVB film 4 was treated (in this case, the film was soaked) for 25 minutes in γ-butyrolactone (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the treated interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 3.08E-05 S/cm.

### Example 11

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of non-conductive PVB film 4 was treated (in this case, the film was soaked) for 25 minutes in anhydrous propylene carbonate (PC) (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 1.36E-06 S/cm.

### Comparative Example for Example 10 and 11

In this comparative example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of non-conductive PVB film 4 was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the interlayer, and slightly offset on one edge from the first FTO piece. The pieces were arranged so that the FTO sides were in contact with the interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film was unable to be determined as it was outside the detection range of the method.

### Example 12

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of non-conductive TPU film 5 was treated (in this case, the film was soaked) for 25 minutes in γ-butyrolactone (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 1.60E-07 S/cm.

### Example 13

In this example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of non-conductive TPU film 5 was treated (in this case, the film was soaked) for 25 minutes in anhydrous propylene carbonate (PC) (Sigma Aldrich, Oakville, ON, Canada) in a dry, inert environment. Upon removal, the film was held to let the excess solvent drip off the film. The film was then gently patted dry using a cleanroom wipe. The treated film was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The treated interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the treated interlayer, and slightly offset on one edge from the first FTO piece. The pieces were arranged so that the FTO sides were in contact with the treated interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film post treatment was determined to be 1.00E-06 S/cm.

### Comparative Example for Example 12 and 13

In this comparative example, fluorine-doped tin oxide (FTO) coated glass substrates (TEC 10; 10 Ω/sq) (Pilkington, Toledo, OH, USA) were cut into 5 cm by 5 cm squares and cleaned with sequential sonication in the following solutions for 15 minutes each: Extran® 300 detergent (VWR, Mississauga, ON, Canada); deionized H2O; acetone (VWR, Mississauga, ON, Canada); and 2-propanol (VWR, Mississauga, ON, Canada). The substrates were dried and the surface was rastered with atmospheric plasma for one minute.

An approximately 4 cm by 4 cm piece of non-conductive TPU film 5 was incorporated into an FTO cell. Edge seal (Quanex Corporation, Houston, Texas, United States) was placed around the edges of one of the 5 cm pieces of fluorine-doped tin oxide (FTO) coated glass (TEC 10; 10 Ω/sq) (Pilkington, Toledo, OH, USA) that had previously been cleaned (as described above). One edge of the seal was offset for the edge to permit busbars to be applied later. The interlayer film was placed onto the center of the edge sealed area with approximately a 0.5 mm gap between the interlayer and the edge seal. A second five centimeter by five centimeter piece of fluorine-doped tin oxide (FTO) coated glass (TEC 10; 10 Ω/sq) (Pilkington, Toledo, OH, USA) that had previously been cleaned was placed on top of the interlayer, and slightly offset on one edge from the first FTO piece. The pieces were arranged so that the FTO sides were in contact with the interlayer. The entire stack was then taped on either side in order to mitigate any chance of electrodes moving before lamination. The entire stack was then placed in a vacuum bag and put in a vacuum oven. The oven was ramped from room temperature to 110 C over 30 minutes, then held at 110 C for two hours. The device was rapidly cooled to room temperature and then removed from the vacuum oven. Once at room temperature, copper bus bars were attached along the blank FTO-coated glass offset edges. Electrochemical impedance spectroscopy (EIS) measurements were taken using a WaveDriver 100 EIS Potentiostat (Pine Research, Durham, North Carolina, USA) and used to calculate the ionic conductivity of the film. Here, the ionic conductivity of the film was unable to be determined as it was outside the detection range of the method.

### Example 14—Exemplary Electrochromic Device Incorporating Modified Film

An approximately 6.5 cm by 6.5 cm piece of non-conductive PVB film 4 was treated (in this case, the film was soaked) for approximately 15 minutes in γ-butyrolactone (Sigma Aldrich, Oakville, ON, Canada) in a dry, inert environment. Upon removal, the film was held to let the excess solvent drip off the film. The film was then gently patted dry using a cleanroom wipe. The treated film was incorporated into an electrochromic cell. A 7.6 cm by 7.6 cm piece of fluorine-doped tin oxide (FTO) coated glass (TEC 10; 10 Ω/sq) (Pilkington, Toledo, OH, USA) that had previously been coated with an anodic or cathodic electrochromic oxide film was obtained. In this case, the substrate had been coated with tungsten oxide. One edge was masked during coating, so a section of blank FTO-coated glass substrate was present. Edge seal (Quanex Corporation, Houston, Texas, United States) was placed around the edges of the 7.6 cm pieces of fluorine-doped tin oxide (FTO) coated glass (TEC 10; 10 Ω/sq) (Pilkington, Toledo, OH, USA). One edge of the seal was offset from the masked edge to permit busbars to be applied late directly onto the FTO coated glass. The treated interlayer film was placed onto the center of the edge sealed area with approximately a 0.5 mm gap between the interlayer and the edge seal. A second 7.6 cm by 7.6 cm piece of fluorine-doped tin oxide (FTO) coated glass (TEC 10; 10 Ω/sq) (Pilkington, Toledo, OH, USA) that previously been coated (except along one edge, which had been masked) with a complementary electrochromic oxide film nickel oxide in this case, was placed on top of on the treated interlayer, and slightly offset on one edge from the bottom coated FTO piece. The pieces were arranged so that the electrochromic layers were in contact with the treated interlayer. The entire stack was then taped on either side in order to mitigate any chance of electrodes moving before lamination. The entire stack was then placed in a vacuum bag and put in an autoclave. The autoclave was ramped from room temperature to 110 C and pressure was taken to 50 psi, changing at a rate of approximately 10 psi per minute, then held at pressure and temperature for two hours. The device was cooled to 60 C and then pressure was ramped back to atmospheric pressure. Once at room temperature, copper bus bars were attached along the blank FTO-coated glass offset edges.

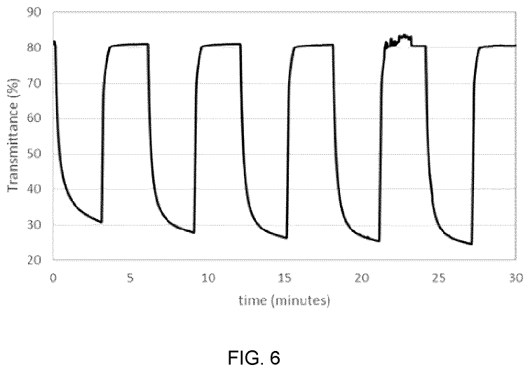

The device was cycled between its coloured and bleached states by applying constant current constant voltage (CCCV) sequences to darken and bleach the device. The change in transmittance at CIE Y scale for the electrochromic device as a function of time was recorded. The bleached state had a transmittance of 80% and the coloured state had a transmittance of 25% at cycle 5. FIG. 6 shows 5 switching cycles for the device.

### INTERPRETATION OF TERMS

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

While processes, steps or blocks are presented in a given order, alternative examples may perform routines having steps, or employ systems having blocks or steps, in a different order, and some processes or steps or blocks may be deleted, moved, added, subdivided, combined, and/or modified to provide alternative or sub-combinations. Each of these processes or steps or blocks may be implemented in a variety of different ways. Also, while processes or steps or blocks are at times shown as being performed in series, these processes or steps or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Various features are described herein as being present in “one embodiment” or in some “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for modifying a property of a prefabricated film, the method comprising:
providing the prefabricated film; and
exposing, for a treatment period and under treatment conditions, the prefabricated film to a solvent to modify the property of the prefabricated film to provide a modified film.

2. The method according to claim 1 or any other claim herein wherein the prefabricated film comprises a prefabricated polymer film.

3. The method according to claim 1 or any other claim herein wherein the prefabricated film comprises aliphatic polyurethane, polyether polyurethane, polyol, thermoplastic polyurethane (TPU), aliphatic polyurethane, polyvinyl butyral (PVB), ethylene vinyl acetate (EVA), or an ionomer.

4. The method according to claim 1 or any other claim herein wherein the prefabricated film comprises thermoplastic polyurethane (TPU).

5. The method according to claim 1 or any other claim herein wherein the prefabricated film comprises polyvinyl butyral (PVB).

6. The method according to any one of claims 1 to 5 or any other claim herein wherein the prefabricated film is a free standing film.

7. The method according to any one of claims 1 to 6 or any other claim herein wherein the prefabricated film is extruded, cast or blown.

8. The method according to any one of claims 1 to 7 or any other claim herein wherein a thickness of the prefabricated film is between approximately 0.05 mm and approximately 4 mm.

9. The method according to any one of claims 1 to 7 or any other claim herein wherein a thickness of the prefabricated film is between approximately 0.15 mm and approximately 1.55 mm.

10. The method according to any one of claims 1 to 9 or any other claim herein wherein the prefabricated film is subjected to a surface treatment prior to the step of exposing the prefabricated film to the solvent.

11. The method according to claim 10 or any other claim herein, wherein the surface treatment comprises formation of micropores and/or nanopores in or on one or both broad surfaces of the prefabricated film.

12. The method according to claim 11 or any other claim herein, wherein the micropores and/or nanopores reduce a density of the prefabricated film by between approximately 0% to approximately 50%.

13. The method according to any one of claims 1 to 12 or any other claim herein wherein the solvent is part of a solution.

14. The method according to claim 13 or any other claim herein wherein the solution comprises a reactive compound.

15. The method according to claim 13 or any other claim herein wherein the reactive compound comprises one or more salts.

16. The method according to claim 13 or any other claim herein wherein the reactive compound comprises one or more alkali metal salts.

17. The method according to claim 16 or any other claim herein wherein a concentration of the one or more alkali metal salts in the solution is between approximately 0.2 M to approximately 2 M.

18. The method according to claim 16 or any other claim herein wherein a concentration of the one or more alkali metal salts in the solution is between approximately 0.8 M to approximately 1.6 M.

19. The method according to claim 13 or any other claim herein wherein the reactive compound comprises one or more of a lithium salt, a sodium salt, and a potassium salt.

20. The method according to claim 13 or any other claim herein wherein the reactive compound comprises one or more lithium salts selected from the group consisting of lithium perchlorate, lithium hexafluorophosphate, lithium tetrafluoroborate, lithium bis(trifluoromethanesulfonyl)imide, lithium bis(fluorosulfonyl)imide, lithium trifluoromethanesulfonate, lithium bis(oxalato) borate, lithium difluoro (oxalato) borate, and lithium 4,5-dicyano-2-(trifluoromethyl) imidazol-1-ide.

21. The method according to claim 13 or any other claim herein wherein the reactive compound comprises one or more of alkali metals, silanes, and siloxanes, moisture scavengers and polymerization initiators.

22. The method according any one of claims 13 to 21 or any other claim herein wherein the solution comprises one or more additives.

23. The method according to claim 22 or any other claim herein wherein the one or more additives are selected from the group consisting of fillers, ultraviolet stabilizers, heat stabilizers, adhesion improvers, antioxidants, radical scavengers, cross linkers, ultraviolet light absorbers, ionic liquids, pigments, dyes, IR absorbers or blockers, surfactants, chelating agents, and impact modifiers.

24. The method according to claim 22 or any other claim herein wherein the one or more additives are selected from the group consisting of reactive adhesion improvers, antioxidants, radical scavengers, cross linkers, ultraviolet light absorbers, Surface Electrolyte Interface (SEI) layer forming compounds.

25. The method according to any one of claims 13 to 24 or any other claim herein wherein the solution comprises an electrolyte solution.

26. The method according to any one of claims 1 to 24 or any other claim herein wherein the solvent comprises a plasticizer.

27. The method according to claim 25 or any other claim herein wherein the plasticizer has an electrochemical window between approximately +1 V to approximately +4 V.

28. The method according to any one of claims 1 to 24 or any other claim herein wherein the solvent comprises one or more plasticizers selected from the group consisting of propylene carbonate, ethylene carbonate, diethyl carbonate, sulfolane, tetraglyme, γ-butyrolactone, triethylene glycol bis(2-ethylhexanoate), diethylene glycol butyl ether, diethylene glycol dibutyl ether, dimethyl glutarate, dimethyl 2-methylglutarate, bis(2-butoxyethyl) adipate, dimethyl adipate, acetyl triethyl citrate, triethyl citrate, diethylene glycol dibenzoate, dipropylene glycol dibenzoate, ethyl methyl carbonate, dipropyl carbonate, dimethyl sulfoxide, β-propiolactone, α-methyl-γ-butyrolactone, γ-crotonolactone, δ-valerolactone, γ-valerolactone, γ-caprolactone, ε-caprolactone, diethoxyethane, dimethyl carbonate, acetonitrile, dimethoxyethane, tetrahydrofuran, and cyrene (dihydrolevoglucosenone).

29. The method according to any one claims 1 to 29 or any other claim herein, wherein the property of the prefabricated film that is modified comprises ionic conductivity.

30. The method according to any one of claims 1 to 29 or any other claim herein, wherein the ionic conductivity of the modified film is at least 20% greater than the ionic conductivity of the prefabricated film as measured via electrochemical impedance spectroscopy.

31. The method according to any one of claims 1 to 29 or any other claim herein, wherein the prefabricated film does not exhibit ionic conductivity and wherein the modified film does exhibit ionic conductivity.

32. The method according to claim 31 or any other claim herein wherein the modified film has an ionic conductivity of at least 1×10⁻⁷ S/cm.

33. The method according to any one of claims 31 and 32 wherein the ionic conductivity is measured via electrochemical impedance spectroscopy.

34. The method according to any one of claims 1 to 33 or any other claim herein, wherein the step of exposing comprises one or more of: immersing the prefabricated film in the solvent, a cut sheet method, a dip bin method, a roll to roll through dip bin method, a cut sheet method in combination with a dip bin method, painting, roller, roll-to-roll, slot die coating, and spray coating.

35. The method according to any one of claims 1 to 34 or any other claim herein, wherein the treatment period comprises between approximately 1 minute to approximately 24 hours.

36. The method according to any one of claims 1 to 34 or any other claim herein, wherein the treatment period comprises between approximately 15 minutes to approximately 180 minutes.

37. The method according to any one of claims 1 to 34 or any other claim herein, wherein the treatment period comprises between approximately 15 minutes to approximately 60 minutes.

38. The method according to any one of claims 1 to 37 or any other claim herein, wherein the treatment conditions comprise a temperature of between approximately 10° C. and approximately 70° C.

39. The method according to any one of claims 1 to 38 or any other claim herein, wherein the treatment conditions comprise a dry atmosphere.

40. The method according to any one of claims 1 to 39 or any other claim herein, wherein the treatment conditions comprise an inert atmosphere.

41. The method according to claim 39 or any other claim herein, wherein the dry atmosphere comprises a dewpoint of less than 0° C.

42. The method according to claim 40 or any other claim herein or any other claim herein, wherein the inert atmosphere comprises argon.

43. The method according to any one of claims 1 to 42 or any other claim herein, further comprising removing excess solvent after the step of exposing.

44. The method according to claim 43 or any other claim herein, wherein removing excess solvent comprises patting with an absorbent material, sparging with dry air, and/or sparging with inert gas.

45. The method according to any one of claims 13 to 25 or any other claim herein, further comprising removing excess solution after the step of exposing.

46. The method according to claim 45 or any other claim herein, wherein removing excess solution comprises patting with an absorbent material, sparging with dry air, and/or sparging with inert gas.

47. A method to manufacture an ion-conducting polymeric interlayer comprising the method of any one of claims 1 to 46 or any other claim herein.

48. An electrochromic device comprising a modified film manufactured according to the method of any one of claims 1 to 46 or any other claim herein.

49. A method of manufacturing an electrochromic laminate device, the method comprising a step of incorporating a modified film in the electrochromic laminate device, the modified film manufactured according to the method of any one of claims 1 to 46 or any other claim herein.

50. A method of forming an electrochromic laminate device, the method comprising the steps of:
a. providing a first coated substrate, wherein the first coated substrate comprises a first transparent conductive layer and at least a first electrochromic layer;
b. providing a second coated substrate wherein the second coated substrate comprises a second transparent conductive layer and at least a second electrochromic layer;
c. providing an interlayer film;
d. treating the interlayer film according to the method of any one of claims 1 to 45 or any other claim herein to form a modified interlayer film;
e. applying the modified interlayer film on the first coated substrate, wherein the modified interlayer film is in contact with at least one electrochromic layer of the first coated substrate;
f. stacking the second glass substrate on the interlayer film opposite the first glass sheet, wherein the modified interlayer film is in contact with at least one electrochromic layer of the second coated substrate, thereby sandwiching the modified interlayer film to form a first assembly; and
g. performing a lamination process comprising subjecting the first assembly to pressure and heat.

51. The method according to claim 50 or any other claim herein wherein the first coated substrate comprising a first coated glass substrate and the second coated substrate comprises a second coated glass substrate.

52. The method according to any one of claims 50 and 51 or any other claim herein wherein the interlayer film comprises a free-standing interlayer film.

53. The method according to any one of claims 50 to 52 or any other claim herein wherein the interlayer film comprises an ion-conducting interlayer film.

54. The method according to any one of claims 50 to 53 or any other claim herein wherein the interlayer film comprises a polymer interlayer film.

55. The method according to any one of claims 50 to 54 or any other claim herein wherein the thickness of the modified interlayer film ranges from approximately 0.100 mm to approximately 2.0 mm.

56. The method according to any one of claims 50 to 54 or any other claim herein wherein the thickness of the modified interlayer film ranges from approximately 0.15 mm to approximately 1.55 mm.

57. The method according to any one of claims 50 to 5565 or any other claim herein wherein the modified interlayer film is transparent after lamination.

58. The method according to any one of claims 50 to 57 or any other claim herein comprising applying busbars.

59. The method according to any one of claims 50 to 58 or any other claim herein comprising applying a sealant material around the perimeter of the modified interlayer film wherein the sealant is in contact with at least one of the conductive layer and at least one electrochromic layer of the first coated substrate.

60. The method according to any one of claims 50 to 59 or any other claim herein, wherein the electrochromic laminate device is subsequently incorporated into an insulated glass unit (IGU).

61. A method of making an electrochemical cell, the method comprising incorporating a modified film manufactured using the method according to any one of claims 1 to 46 or any other claim herein into the electrochemical cell, wherein the electrochemical cell optionally comprises a battery, a capacitor or a supercapacitor, wherein the battery is optionally a lithium ion battery or a sodium ion battery.

62. A method of forming an electrochromic laminate device, the method comprising the steps of:
a. providing a first coated substrate wherein the first coated substrate comprises a first transparent conductive layer and at least a first electrochromic layer;
b. providing a second coated substrate wherein the second coated substrate comprises a second transparent conductive layer and at least a second electrochromic layer;
c. providing an interlayer film, wherein the interlayer film is treated to increase its ionic conductivity by exposing the interlayer film to a solvent to make a modified interlayer film;
d. applying the modified interlayer film on the first coated substrate, wherein the modified interlayer film is in contact with at least one electrochromic layer of the first coated substrate;
e. stacking the second glass substrate on the interlayer film opposite the first glass sheet, wherein the modified interlayer film is in contact with at least one electrochromic layer of the second coated substrate, thereby sandwiching the modified interlayer film to form a first assembly; and
f. performing a lamination process comprising subjecting the first assembly to pressure and heat.

63. The method according to claim 62 or any other claim herein wherein the first coated substrate comprising a first coated glass substrate and the second coated substrate comprises a second coated glass substrate.

64. The method according to any one of claims 62 and 63 or any other claim herein wherein the interlayer film comprises a free-standing interlayer film.

65. The method according to any one of claims 62 to 64 or any other claim herein wherein the interlayer film comprises an ion-conducting interlayer film.

66. The method according to any one of claims 62 to 65 or any other claim herein wherein the interlayer film comprises a polymer interlayer film.

67. The method according to any one of claims 62 to 66 or any other claim herein wherein the thickness of the modified interlayer film ranges from approximately 0.100 mm to approximately 2.0 mm.

68. The method according to any one of claims 62 to 66 or any other claim herein wherein the thickness of the modified interlayer film ranges from approximately 0.15 mm to approximately 1.55 mm.

69. The method according to any one of claims 62 to 68 or any other claim herein wherein the modified interlayer film is transparent after lamination.

70. The method according to any one of claims 62 to 69 or any other claim herein comprising applying busbars.

71. The method according to any one of claims 62 to 70 or any other claim herein comprising applying a sealant material around the perimeter of the modified interlayer film wherein the sealant is in contact with at least one of the conductive layer and at least one electrochromic layer of the first coated substrate.

72. The method according to any one of claims 62 to 71 or any other claim herein, wherein the electrochromic laminate device is subsequently incorporated into an insulated glass unit (IGU).

73. Methods comprising any features, combinations of features and/or sub-combinations of features described herein or inferable therefrom.

74. Apparatus comprising any features, combinations of features and/or sub-combinations of features described herein or inferable therefrom.

75. Kits comprising any features, combinations of features and/or sub-combinations of features described herein or inferable therefrom.
